(19) United States
(12) Patent Application Publication
(10) Pub. No.: US 2005/0163904 A1
(43) Pub. Date: Jul. 28, 2005

(54) Foam forming particles and methods

(75) Inventors: Bright Walker, Berkeley, CA (US); David Soane, Chestnut Hill, MA (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: DuraFizz, LLC, Emeryville, CA (US)

(21) Appl. No.: 10/958,926

(22) Filed: Oct. 4, 2004

Related U.S. Application Data
(60) Provisional application No. 60/543,384, filed on Feb. 10, 2004.

(30) Foreign Application Priority Data
Jan. 22, 2004 (US) 04/01628

(51) Int. Cl. A23L 1/00

(52) U.S. Cl. 426/564

(57) ABSTRACT

A composition is formed by compounding a first substance with a second substance. The first substance includes a bicarbonate, an acid or a combination thereof. The second substance includes a frothing agent, a coating agent or a combination thereof. The composition may be formed into coated particles or a mass of particles coated by a matrix, such as a matrix of the frothing agent. The particles or mass of particles may have more than one coating. The compound is used for preparing a stable froth on a beverage, such as a hot cup of cappuccino. The frothing agent may include not only compounds that enhance the stability of the foam but also compounds that enhance other characteristics of a desirable froth. The coating agent may be used to delay the reaction between a bicarbonate and an acid when the compound is added to water, such that a large volume of froth is produce, but undesirable flocculation, turbidity and increases in viscosity are avoided.

### FIELD OF THE INVENTION

The field of the invention is instant beverages, especially the preparation of instant cappuccino having a thick, frothy head on the surface.

### BACKGROUND

Conventional cappuccino is prepared by separately frothing milk, using a steamer, and brewing espresso using a pressure espresso machine. Usually, some hot, steamed milk is added to the espresso and, then, the frothy, steamed milk is spooned onto the surface of the espresso, providing an adequate thickness of frothed milk on the surface of the hot mixture of espresso and milk. The foam provides both a satisfying taste and texture that is difficult to duplicate by any other process.

Specifically, the process of conventional froth formation involves a volume of air being introduced into a volume of vigorously agitated milk and dispersed into small bubbles. The turbulence is caused by high-pressure, super-heated steam being jetted into the mixture, and the steam acts to scald the milk slightly as well as agitate it. The simultaneous scalding and agitation, if done properly, causes tiny air vesicles to be surrounded by a flexible, durable film of partially scalded, cured milk.

Some instant cappuccino formulations have been prepared by incorporating a powdered bicarbonate salt as well as a solid, powdered acid with a powdered instant coffee and creamer formulation. When water is added, the acid decomposes the bicarbonate salt resulting in a reaction that releases bubbles of carbon dioxide (CO₂) gas. If properly prepared the bubbles form a foam; however the foam is prone to collapse quickly unless certain stabilizing agents are added (Kraft, U.S. Pat. No. 5,780,092). Stabilizing agents are known, such as certain pairs of edible biopolymers. Pairs in which one biopolymer has a net positive charge and the other a net negative charge conjugate via electrostatic and osmotic interactions into film-stabilizing bilayers, which form metastable foam that is in some ways similar to the stable froth of steamed milk foam (Poole, UK patent GB 2 179 043, U.S. Pat. No. 4,572,837) However, the edible polymers conjugate, causing flocculation and the liquid phase of the coffee becomes turbid and viscous during foam formation. Alternatively, the edible polymers might fail to dissolve, entirely. In either case the result is an unappealing mixture that fails to have the desired flavor and texture of a frothed milk foam.

It well known that egg albumen, i.e. egg whites, are effective foam stabilizing agents for use in instant cappuccino formulations using bicarbonate salts to generate the foam bubbles. (U.S. Pat. No. 6,048,567 Proctor and Gamble, U.S. Pat. No. 5,462,749, Westerbeek) However, albumen has a tendency to coagulate in hot water, causing turbidity, which can be seen in egg-drop soup, for example. This effect is distinctly unappealing in coffee beverages.

Whey protein is another foam stabilizing agent that suffers from flocculation. Whey protein is sensitive to pH and acidity present during the gas-generating reaction in instant cappuccino, resulting in the flocculation of the whey protein.

It would be advantageous commercially to have a composition that generates a milk froth substitute for hot beverages that avoids the problems of coagulation, flocculation and turbidity commonly associated with the use of proteins and biopolymers.

The cohesive energy density of a solvent may be derived from the known heat of vaporization of a solvent, using the following expression:
c=(ΔH−RT)÷Vₘ (1)
where c is defined as the cohesive energy density (in MPa), ΔH is defined as the heat of vaporization of the solvent (in N m mol⁻¹), R is defined as the gas constant (in N m mol⁻¹ K⁻¹), T is the temperature of the solvent (in K), and Vₘ is defined as the molar volume (in m³ mol⁻¹). The cohesive energy density of a liquid is a numerical value that indicates the energy of vaporization in calories per cubic centimeter, and is a direct reflection of the degree of van der Waals forces holding the molecules of the liquid together. The correlation between vaporization and van der Waals forces is known to provide a correlation between vaporization and solubility behavior of a solute in a solvent. The intermolecular forces that are in play during vaporization are also in play during dissolution. It is known that solubility increases, when the intermolecular forces of the solute and solvent are chosen to be similar. Since the 1950's, it has been accepted that Hildebrand's solubility parameter (δ) is indicative of the solvency behavior of a specific solvent for a particular solute and is reported herein in units of MPa^{1/2}, unless otherwise noted, and ∂ is equal to the square root of the cohesive energy density, c.

### SUMMARY

A frothy beverage may be prepared by the addition of hot water to a froth-producing mixture including a bicarbonate, an acid, a frothing agent and a coating agent. Other compounds may be used instead of a bicarbonate that likewise react with an acid to form gas bubbles. The compound is selected to be one that is both palatable and safe for human consumption. Additives may be added to give the frothy beverage flavor, color, texture and other desired qualities. For example, the frothy beverage may be a cappuccino by using additives that provide the mixture with an instant espresso and milk combination. The beverage may be prepared immediately before consumption without separately steaming milk, while simulating the features of a conventionally prepared cup of cappuccino, for example.

The frothing agent provides a stable froth on the surface of the beverage. By stable, it is meant that at least a substantial portion of the froth remains on the surface of the cappuccino in a way that is apparently similar to or better than the foam created by preparing steamed milk foam by hand for a period of at least 3 minutes, more preferably 5 minutes. As the mixture dissolves in hot water, bubbles form by the reaction of the acid and the bicarbonate. The frothing agent stabilizes the bubbles, such as by forming a stable film around the bubbles. Then, the stable bubbles rise to the surface and form a froth on the surface of the cappuccino, imparting the desired, smooth and creamy texture of steamed milk foam on a cappuccino.

The acid may be present in the form of a powder, for example. The particle size of the powder may be determined by the acid's rate of dissolution and pKₐ values. Preferably, the acid dissolves rapidly to produce an “instant” cappuccino. Herein “instant” relates to a product that is prepared quickly without the need for special steaming equipment and the like, such as instant coffee products. It may take some time and stirring to produce the “instant” beverage, but does not take the skill and equipment required for hand steaming of milk.

The terms “bicarbonate salt” and “bicarbonate” are used interchangeably and refer to edible salts of alkali metals, alkaline earth metals, ammonia, guanidine, glycine or other nitrogen bases and carbonic acid, such as NaHCO₃, Na₂CO₃, KHCO₃ or K₂CO₃. Any edible compound that is capable of reacting with an acid to form bubbles may be used as a substitute for a bicarbonate and is included within the definition thereof.

The terms “acid” or “edible acid” refer to any edible, solid acid, such as gluconolactone, gluconic acid, citric acid, tartaric acid, malic acid, malonic acid, succinic acid, glutaric acid, adipic, ascorbic acid, any acidic biopolymer, or monobasic salts of phosphoric acid, and also including combinations thereof.

The term “biopolymer” refers to any edible substance having a molecular weight of greater than 1,000 amu which is derived from a biological source. Biopolymers include, without limitation, “acid biopolymers” and “basic biopolymers” which are subsets of the more general “biopolymer” group. Another example of biopolymers is neither acidic nor basic, including biopolymers such as guar gum, xanthan gum, gum Arabic, dextrin, dextran, shellac, ethyl cellulose, starches, neutral milk solids, carrageenan and egg albumin.

An “acid biopolymer” has a net excess of acidic functionalities or is a protein with an isoelectric point of less than 6, such as whey protein isolate, nonfat milk solids, pectin, CMC, casein or their salts.

A “basic biopolymer” has a net excess of basic functionalities or is a protein with an isoelectric point of greater than 9, such as egg whites, lysozyme, chitosan or their salts.

A “frothing agent” is any substance which favorably contributes to the stability, texture, flavor or appearance of the froth. Such substances include sweeteners, thickeners, creamers, coffee or surfactants, such as sucrose, fructose, guar gum, xanthan gum, pectin, casein and its salts, nonfat milk solids, whey proteins, powdered nondairy creamer, instant coffee, a sorbitan-ester surfactant impregnated into solid phosphate salts (e.g. PBS Tween), silica, malt extract and combinations thereof. The frothing agent may be compounded with the bicarbonate, the acid or both and may also serve as a coating agent.

A “coating agent” is a substance that delays the reaction of the bubble forming reagents by coating one or more of the reagents with a shell. The shell may be soluble in water, partially soluble water or insoluble in water; however, the shell prevents or slows reaction of the reagents (i.e. an acid and a bicarbonate) until adequate wetting of the composition after water is added to create a beverage. Examples include shellac, alkyl celluloses such as methyl cellulose, ethyl cellulose, hydroxypropyl cellulose, hydroxypropylmethyl cellulose, and hydroxyethylmethyl cellulose, starch derivatives, sugars, and polyvinylpyrrolidone. For example, the solubility of polysaccharides, such as cellulose and starch derivatives, may be adjusted by selecting a degree of substitution that makes them insoluble in water or delays dissolution in water at a temperature greater than the temperature that causes flocculation of one or more of the additives. Even a coating soluble in water within the range of water used to make hot beverages may be useful in delaying the reaction, if dissolution prevents an immediate reaction between the reagents. Also, the coating agent may serve as a frothing agent.

The terms “pKₐ”, “pka” and “pka value” are used interchangeably and refer to the negative logarithm of the equilibrium constant of the dissociation reaction of an acidic substance into its conjugate base and a proton in aqueous solution. In the case of a substance with multiple dissociable protons, the term refers to the most dissociable proton or lowest of the possible values unless otherwise noted.

### BRIEF DESCRIPTION OF THE DRAWINGS

A brief description of the drawings follows. The drawings and description of specific examples are not intended to limit the scope of the invention. Instead, the invention is given the broadest reasonable scope based on the ordinary and accustomed meaning of the claim terms, as those terms are defined herein, or if not defined herein, as understood by a person of ordinary skill in the art of food packaging.

FIG. 1 shows one embodiment of a coating morphology used in the present invention.

FIG. 2 shows another embodiment.

FIG. 3 shows yet another embodiment.

FIG. 4 shows still, yet another embodiment.

### DETAILED DESCRIPTION

In one example, the rate of dissolution of the acid and pKₐ of the acid, as that term is defined herein, are selected such that, the pH of the beverage is maintained at a level that avoids noticeable flocculation of any acid sensitive proteins or biopolymers during dissolution of the acid and formation of the froth. For example, the acid may be compounded with one or more soluble ingredients, such as sucrose, dextrin, albumen, chitosan, cellulose gum, xantham gum, guar gum, pectin and combinations thereof, to control the dissolution rate of the acid. In one example, an acid having a pKₐ in a range greater than 3.5 is used. Specific examples include: adipic, ascorbic, glutaric, succinic and gluconic acids. Alternatively, any acid may be used if measures are taken to prevent the pH of the beverage from becoming too low at any point in the foam generation process. For example, citric, tartaric and malic acids may be used, if measures are taken to prevent too rapid of an increase in the pH. The frothing agents and acid may be selected for compounding together, for example. Compounding frothing agents and acids may synergistically aide in dissolution of the frothing agents. For example, a basic biopolymer such as chitosan, has a substantial foam stabilizing effect when used in conjunction with an acid biopolymer. Chitosan is only soluble in acidic solutions. Thus, dissolution of Chitosan is greatly accelerated by compounding the Chitosan with the acid. For example, the Chitosan and the acid may be compounded prior to powdering the compound and addition of the powdered compound to a powdered instant beverage powder.

Compounding and compounded mean to produce or create by combining two or more ingredients or parts into a mixture. The compounded mixture brings the two or more ingredients into intimate contact or close proximity, but a substantial chemical reaction between the ingredients is avoided.

It is important to have substantially no flocculation of any proteins and biopolymers added to the mixture. By substantially no flocculation, it is meant that the amount of flocculation that occurs is insubstantial, such that it does not lead to an excessive increase in the beverages turbidity and viscosity that impairs the consumers enjoyment of the beverage.

For example, the morphology of the bicarbonate particles, which are encapsulated or otherwise compounded with one or more frothing agents, is used to reduce or prevent flocculation of any proteins and biopolymers in the frothing agents after introduction of hot water. By compounding the frothing agents with the bicarbonate particles, the frothing agents may be concentrated in the froth on the surface of the beverage, where they stabilize the bubbles that comprise the froth, reducing the amount of frothing agents necessary to generate any specifically desired volume of froth on the surface of the beverage. Thus, there is a significant commercial advantage to compounding the bicarbonate particles with the frothing agent, because using less frothing agent substantially reduces the cost of the product compared to a product using an excess of frothing agent that remains in the beverage. Furthermore, an excessive viscosity of the beverage is avoided by concentrating the frothing agent in the froth.

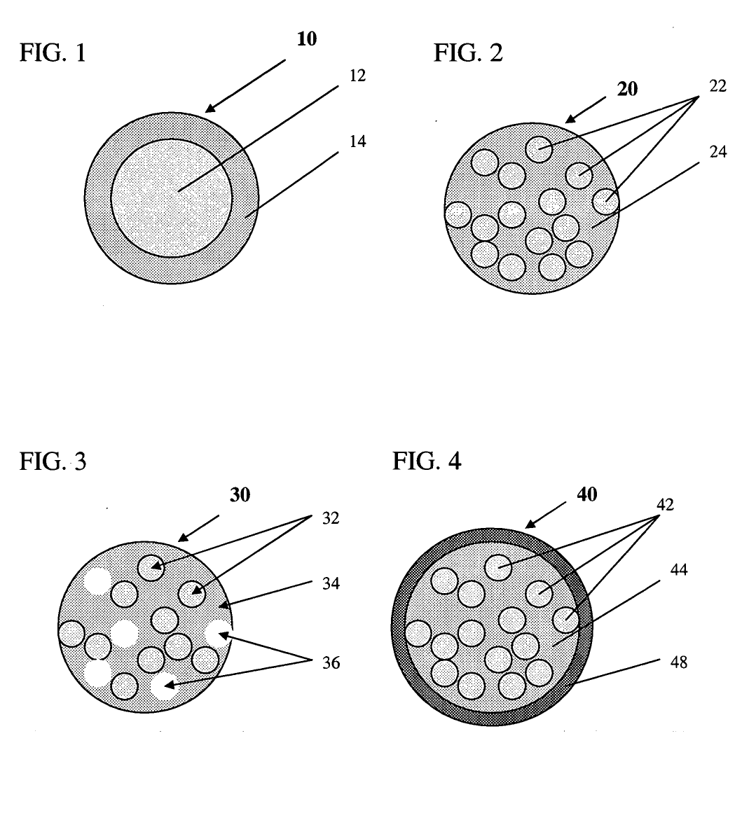

FIG. 1 shows one embodiment of a coated particle 10 comprising a core 12 having a coating 14. The particle 10 and the core 12 are shown as spheres, but they need not be spherical. An irregular shape is acceptable. Likewise, the coating 14 is shown as homogenous, continuous and regular; however, the coating 14 may be inhomogeneous, discontinuous and irregular. The representations of FIGS. 1-4 are merely schematic.

For example, the particle 10 comprises a bicarbonate in the core 12 and a frothing agent in the coating 14 in a compounded coated particle 10. For example, the frothing agent may be selected to be a protein, a biopolymer or combinations thereof. The frothing agent is coated on the surface of the core 12. The coating is not limited to one foam enhancing agent, but may include any combination of foam-enhancing substances that may physically be incorporated into the coating, such as sugars, creamers, surfactants, flavoring agents, thickeners, and the like. Many particles 10 are used to prepare a beverage by adding hot water, for example. The number of particles 10 that are used depends on the size of the particles 10, the amount of the beverage to be prepared and the volume of froth desired on the surface of the beverage. These factors may be adjusted to taste. It is believed For example, the size of the particles 10 may be selected in a range from 20 to 500 microns. More preferably, the size of the particles 10 is selected in a range from 20 to 250 microns, such that no substantial dry particles are entrained by the bubbles into the froth. In one embodiment, the amount of liquid in the froth is sufficient to react any small, entrained particles, providing a froth with an attractive appearance.

In one example, the core 12 is a bicarbonate powder compounded with a solid, edible acid, such as a powdered acid. Thus, the acid and the bicarbonate are in close proximity to each other, and the acid is quickly neutralized by the bicarbonate after the addition of water, limiting any increase in the pH of the beverage and avoiding flocculation of any acid-sensitive proteins and biopolymers. The coating 14 may be porous or may be subject to dissolution in water.

In another example, the acid may be compounded with the frothing agent in the coating 14 or may be added separately from the coated particle 10. Specific examples of the frothing agent include, without limitation, albumen, whey protein isolate, milk solids, sucrose and starch. It is preferred to have the acid in close proximity to the bicarbonate to limit the increase in pH of the beverage if acid-sensitive additives are used, in order to avoid flocculation of the acid-sensitive additives.

The composition of the particles 10 is not limited to bicarbonate, acid and frothing agents. Instead, other components that are useful for producing a satisfying beverage may be included, such as sweeteners, coffee, flavoring agents, creamers, thickeners and the like. For example, such additives may be powders compounded with the core 12 or coating 14 of the particles 10. Alternatively, these additives may be added separately from the frothing agent, bicarbonate and acid.

In one example, the coating includes an albumen additive. In this example, thermal coagulation of the albumen does not occur simultaneously upon addition of the hot water that forms a cappuccino, for example. Instead, any substantial coagulation may be delayed long enough for bubbles to form. By positioning the albumen within close proximity of the substances forming the bubbles, the albumen may substantially coat the bubbles. The subsequent coagulation of the albumen causes substantially all of the coagulated albumen to end up in the froth. The characteristics and timing of albumen coagulation may be adjusted by incorporating other foam-enhancing substances into the coating, by varying the thickness of the coating and by varying the overall particle size. By adjusting the characteristics of the coagulation process, a stable froth is formed that is thick, creamy and appealing to cappuccino consumers. The liquid portion of the beverage has substantially no turbidity and no excessive increase in viscosity, as opposed to the undesirable increase in turbidity and viscosity seen in previous attempts to use albumen to stabilize a froth in instant hot beverages.

In another example, the coating includes a whey protein isolate or other acid sensitive proteins or biopolymers as a frothing agent. In this example, the location of the basic bicarbonate salt is used to ensure that the pH is relatively high in the localized region of the particle for a period sufficient to generate bubbles of CO₂ prior to coagulation of the frothing agent on the surface of the bubbles. The close proximity of the frothing agent to the bubbles causes most of the frothing agent to be carried into the froth. This occurs regardless whether the frothing agent is coagulated or not. For example, the characteristics the coagulation of a protein frothing agent may be controlled by incorporating other foam-enhancing substances into the coating, by varying the thickness of the coating and by varying the overall particle size. The froth generated in this manner is thick and appealing to consumers of cappuccino, and the liquid portion of the beverage has no substantial increase in turbidity or viscosity.

In FIG. 2, a “cookie” morphology is shown, schematically. The cookie morphology may be spherical, but it is not limited to any particular shape. The cookie morphology has a mass 20 comprising particles 22 compounded within a matrix 24. In one embodiment, the bicarbonate and frothing agent are compounded in the mass 20 having particles 22 of a bicarbonate embedded in a matrix 24 of the frothing agent, such as a protein, biopolymer or combinations thereof. The effects are similar to the coating morphology shown in FIG. 1, but the preparation is different. The size of the particles 22 may be similar to the size of the core 12 in FIG. 1, or may be smaller.

The mass 20 may take any shape and size that provides for rapid production of an acceptable froth. In one example, the mass 20 has a disk-like shape of a cookie or hockey puck. By forming the mass 20 in a cookie shape, the mass is more easily packaged, and the mass 20 has a greater surface area per volume (aspect ratio), which allows more water to contact the surface of the mass 20 compared to a similar volume in the shape of a sphere. Other shapes with even greater surface area per volume are easily envisioned, and the description of this example as a cookie morphology does not exclude any of these shapes. The size and shape of the mass 20 influences the rate of dissolution and reaction between the acid and the bicarbonate. The acid and bicarbonate may be compounded in the particles 22, the matrix may contain the acid, or the acid may be located elsewhere. It is preferred to have the acid and the bicarbonate in close proximity if acid-sensitive compounds are used. In one embodiment, the mass 20 is globular (i.e. somewhat spherical), and the size of the mass 20 is alternatively selected as fine (i.e. less than 53 microns) or granular (i.e. greater than 106 microns). Other sizes and shapes may be used, also, depending on the presence or absence of coating agent coatings, as shown in FIG. 4, and the like.

In FIG. 3, a “foamed mass” morphology is shown, schematically. For example, the foamed mass 30 may be similar to the cookie morphology, except for gaseous vesicles 36 being introduced into the mass 30. The effect of the incorporated air vesicles is to decrease the bulk density of the mass 30. By altering the bulk density of the mass 30, the extent to which the mass 30 is wetted before the froth forms is controlled and further concentration of the frothing agent within the froth is achieved.

In FIG. 4, a “double coating” is shown schematically. Any of the embodiments shown in FIGS. 1-3 may be modified by adding one or more additional coatings. For example, coated particles of acid may be included in a cookie morphology such as in FIG. 2, bicarbonate particles such as shown in FIG. 1 may be coated by a second coating agent, or combinations thereof. By adding specific additional coatings, dissolution of any of the compounds may be delayed. Thus, the rate of dissolution of the bicarbonate, acid and frothing agent may be adjusted using a coating that dissolves or is penetrated by water over time. In some embodiments, multiple coatings are applied to multiple particles before forming a foamed mass such as shown in FIG. 3, such that dissolution of the components is delayed and good wetting of the particles occurs prior to the onset of any substantial amount of frothing.

Also, by coating with an insoluble or slowly soluble substance, it is possible to separate two sets of components and delay their interaction. The first set of uncoated components dissolves relatively quickly upon addition of hot water, while the second set of components, which are trapped within an insoluble but permeable shell, for example, are prevented from instantaneous dissolution. Though insoluble, the coating is not impervious and inevitably some acid interacts with the bicarbonate within the shell, generating CO₂ and breaking the shell. The ensuing generation of CO₂ pushes the second set of components out of the protective shell. Interactions between the two sets of components specifically occur at breaks in the shell or coating.

In one specific example, this effect is applied to pairs of acidic and basic biopolymers. The effect is that when water is added, the acid and first component of the biopolymer couple dissolve first. For example, the basic biopolymer, such as chitosan and lysozyme, may dissolve first, and the second biopolymer, such as an acidic biopolymer selected from whey protein isolate, nonfat milk solids and combinations thereof, dissolves when the shell breaks during CO₂ generation. Once outside of the shell, the second biopolymer is available to conjugate with the first biopolymer, which entrap the CO₂ bubbles within a flexible, durable film of the coupled biopolymer pair. The stiffness of the film may be controlled by adjusting the quantities of acidic and basic biopolymers or by including other frothing agents with the biopolymers. For example, sucrose is useful in adjusting the stiffness of the film, imparting a smooth and satisfying taste and feel to the froth. By adjusting the amount of the ingredients, the froth takes on the texture and taste of frothed milk prepared by hand steaming, as done in preparation of conventional cappuccino. Instead of scalding the milk proteins, the milk proteins (if used) are captured by the coupling of the biopolymers, for example. The frothing agents are concentrated in the froth and the liquid portion of the beverage remains palatable with substantially no turbidity.

In another example, the particles are coated with a slowly soluble substance, such as a sugar or starch, which delays dissolution of the particles. The slowly soluble substance produces the same effect as described for an insoluble but permeable coating. The slowly dissolving coating may also be used to simply delay the acid-base reaction and simultaneously alter the surface/mass ratio of the particles, which may be used to increase the amount of wetting of the particles.

One advantage of a double coating is that the double coating provides both a delayed reaction and an increased surface to mass ratio. Thus, the particles initially sink into the liquid part of the beverage further and are more thoroughly wetted by the liquid before frothing, which may increase the liquid content of the froth compared to the same compounds without the double coating.

By coating the particles with a weak acid, such as adipic acid, it is possible to ensure that enough acid is present in the froth to cause a more complete decomposition of bicarbonate.

Any combination of the above mentioned embodiments may be used to achieve the desired effect in the finished beverage.

### EXAMPLES

All percentages listed are by weight unless otherwise specified. The terms “particle size” or “mean particle size” refers to the diameter of a spherical particle of equivalent volume to the mean volume of actual particles, which may or may not have a spherical shape.

Bicarbonate Preparations

A bicarbonate salt powder (e.g. NaHCO₃ or KHCO₃ with a mean particle size selected in a range from about 20 to about 500 μm) is intimately mixed with some combination of finely powdered, water soluble biopolymers, preferably egg albumen powder and/or whey protein isolate, (e.g. mean particle size selected in a range from about 0.001 to about 20 μm). The mass of the albumen is selected in a range from about 5% to 500% of the mass of the bicarbonate, more preferably 50% to 300%. The mass of whey protein isolate is selected in a range of about 5% to 500%, more preferably 50% to 300%, of the mass of the bicarbonate. Other powdered biopolymers or foam enhancers may be substituted or included.

In one process of preparing the composition, a mean particle size of the powdered coating material is selected such that the mean particle size of the powdered coating material is significantly smaller than the mean particle size of the bicarbonate salt. A small amount of water is added dropwise, or as an atomized mist. The amount of water varies depending on the solubility of the biopolymer chosen. The amount of water may be selected such that the material only just appears damp, for example in a range from about 1% to 50%, and more preferably 3% to 30%, of the total mass of powder. The mixture is vigorously stirred, mixed or shaken and may clump slightly. Preferably, the clumps are broken up by agitation, vibration or another process. The mixture may be gently heated while being agitated until it is dry. By the term gently heated, it is meant that care is taken not to thermally decompose the bicarbonate salt or the biopolymer. Depending on the amount of albumen or coating agent to be compounded, it may be necessary to add the albumen or coating agent in small portions and repeat the addition of water and drying with each successive addition of albumen (or other frothing agent or coating agent). After being dampened, mixed and dried a sufficient number of times, the material looks roughly like the bicarbonate starting material, but the material has at least a partial coating on the particles of bicarbonate, such as that shown in FIGS. 1-3 for completely coated particles.

Alternatively the coating may be applied by repeatedly dampening the material with a dilute solution of biopolymer or coating agent and drying. The ratios of bicarbonate to biopolymers remain the same as the above preparation, but the biopolymer is first dissolved in this example. The biopolymer or coating agent is dissolved in water and applied to the powder dropwise or as an atomized mist. The process proceeds as in the example for a powdered biopolymer or coating agent.

The process of drying may use a fluid bed drier, or example. Again, care is taken not to thermally decompose the bicarbonate salt or the biopolymer used, especially if heat is applied during drying. Fluid bed drying can prevent some clumping and prevent some of the agglomeration of the coated particles.

In another embodiment, a bicarbonate salt powder, (e.g. NaHCO₃ or KHCO₃, having a mean particle size selected in a range from about 0.001 to 100 μm) is intimately mixed with some combination of finely powdered, water soluble biopolymers, preferably egg albumen powder and/or whey protein isolate (e.g. mean particle size selected in a range from about 0.001 to 20 μm). Optionally, other foam enhancing components may be included with the biopolymer. For example, the mass of the albumen is selected in a range from about 5% to 500% of the mass of the bicarbonate used, more preferably 50% to 300%. For example, the mass of whey protein isolate is selected in a range from about 5% to 500%, preferably 50% to 300%, of the bicarbonate used. A small volume of water (e.g. 5% to 150% of the overall mass) or aqueous bicarbonate solution is added to the mixed powder, and is mixed to a paste, spread thin on a clean surface and allowed to dry in a cookie morphology. The film may be gently heated to speed the drying process. Once dry, the material is ground to the desired particle size for use in the finished beverage formulation, or further encapsulation as described in part 4 below. In one example, a first compound made from bicarbonate and albumen and a second compound made from bicarbonate and whey protein are mixed together with a conventional cappuccino mix, an acid, a whey protein isolate and a cellulose gum to form a composition for use in preparing an instant cappuccino mix with a froth resembling a hand steamed milk froth.

In another example, the cookie morphology may be prepared by spray drying a saturated solution of bicarbonate containing dissolved biopolymer. Crystallites of bicarbonate form as the solution evaporates in the spray-drying tower. Optionally, fine bicarbonate powder (e.g. mean particle size selected in a range from 0.01 to 50 μm, more preferably 0.2 to 10 μm) may be suspended in the solution provided that the emulsion is compatible with the spray-drier being used. In an example using albumen, the mass of the albumen is selected in a range from about 5% to 200% of the combined mass of the bicarbonate salt present, more preferably 25% to 150%. The term about is used here to indicate that these are changed when other ingredients are added. The range selected is determined experimentally by determining when the frothing process produces a desired volume of froth that is substantially free of undissolved/unreacted particulates, and substantially no flocculation and turbidity are detected in the liquid portion of the beverage. Typically, the mean particle sizes and other ranges may be selected using an iterative process of pouring boiling water into beakers containing an array of frothing additives, although some adjustments may be necessary when coffee, sweeteners and milk proteins are added to the mix.

For example, when using whey protein isolate, the mass of whey protein isolate is selected in a range from 10% to 400%, preferably 50% to 300% of the bicarbonate used. Optionally, other frothing agents may be included with the biopolymer provided that they are soluble in water. In the case that no additional bicarbonate powder is added, the viscosity of the solution may be adjusted by diluting with water to meet the needs of the spray-dryer being used.

In yet another embodiment, the preparation of a foamed mass morphology is identical to that of the “Cookie Morphology” except that air is allowed to become incorporated into the paste during the mixing process. The amount of air included may be varied to affect the density of the final powder, which may range from 0.3 g/mL to 3.0 g/mL, preferably 0.8 g/mL to 2.0 g/mL, though the optimal value is strongly dependant on the formulation, the rate of foam generation and wetting characteristics of the formulation.

In still yet another embodiment, coated bicarbonate particles prepared using these methods may be further encapsulated with a water-insoluble coating agent or a coating agent slightly soluble in hot water, e.g. a shellac or a cellulose ether, such as an ethylcellulose resin, which is an organosoluble, thermoplastic polymers that is prepared by the reaction of ethyl chloride with alkali cellulose (available by the trade name Ethocel™ from Dow Chemical Company). The powder is mixed with a solution of the polymer in a suitable solvent. For example, ethanol and isopropanol may be used as solvents. The dry mass of polymer used is about 2% to 70% of the mass of the particles to be encapsulated, more preferably 5% to 50%, and even more preferably 10% to 40%. The amount of solvent used is 5 to 50 times the mass of the polymer, more preferably 15 to 30 times the mass of the polymer. To facilitate stirring and agitation, the total solvent volume may be increased by adding acetone in an amount up to but not exceeding the volume of the alcohol used. The mixture is stirred, and a selected hydrophobic nonsolvent for the polymer is added as slowly as possible. The nonsolvent may have an overall Hildebrand parameter of less than 20 MPa^{1/2}, more preferably less than 18 MPa^{1/2}. Examples of nonsolvents are ethyl ether, butyl acetate and hexane. The volume of nonsolvent may be 5 to 20 times that of the solvent used. The solvent mixture is decanted and the powder washed twice with nonsolvent. The powder is isolated by filtration and dried.

Alternatively, a hydrophobic coating may be applied using supercritical CO₂. The hydrophobic coating agent is dissolved in supercritical CO₂. The dry mass of coating agent used is selected in a range from about 2% to 70% of the mass of the particles to be encapsulated, more preferably about 5% to 50% and even more preferably 10% to 40%. The polymer is mixed with the particles in a high-pressure vessel equipped with a mechanical or magnetic stirring apparatus. The CO₂ pressure is increased until the entire mass of polymer has dissolved. The powder is then agitated while the CO₂ pressure is very slowly decreased. After all of the coating agent has come out of solution, the pressure in the vessel is returned to ambient and the material is collected.

Alternatively, any particles prepared by these methods may be further encapsulated with a water-soluble coating agent by repeating process described in section 1, using a biopolymer or foam enhancing agent which has a greater solubility in water than the original coating substance.

Alternatively, an outer coating may be applied using a biopolymer or coating agent which is soluble in a suitable organic solvent, repeating the process described in section 1, with the exception that an organic solvent takes the place of water. The solvent may be any suitable solvent which dissolves the coating agent, preferably ethanol, isopropanol, acetone or butyl acetate. For example, some coating agent/solvent combinations are fructose/ethanol, sucrose/ethanol, carnauba wax/butyl acetate. For example, the preferable coating agents are applied as a concentrated solution in their respective solvents.

In another embodiment, the coating 14, 24, 34, 44 may include an acid, which later reacts with the bicarbonate. The acid may be included by dissolving a suitable acid in a nonpolar solvent. The acid preferably has a first pKa value of greater than 3, and more preferably greater than 3.5. The solvent is suitably nonpolar such that solubility of bicarbonate is negligible. In this way, the reaction of acid with bicarbonate is found to be negligible over short periods of time, specifically during a quick compounding process that leaves a coating that comprises the acid. The coating may also include other compounds, such as a frothing agent or a compound that slows the dissolution of the coating. One example of an acid and solvent combination is adipic acid and acetone.

For example, the following process may be used to coat bicarbonate particles with a coating comprising adipic acid. A concentrated solution of adipic acid in acetone is prepared, and this is applied dropwise or as an atomized mist to the powder which is to be coated. The powder is made damp, but not soaked while being continuously stirred and gently heated. Care is taken that the evaporation of the solvent does not cool the mixture to the extent that condensation forms, as even small amounts of water may cause a premature reaction of acid and base. After sufficient acid has been applied, the mixture is allowed to dry and has roughly the same appearance as the bicarbonate starting material.

Acid Preparation

Acids may be used as received from the supplier for convenience. In the event that the dissolution rate of the acid needs to be adjusted, the compounding of the acid with another ingredient is effected by dissolving the acid and other ingredient(s) to make a concentrated solution. The solution is dried by any convenient method, and optionally ground to achieve the desired particle size. Preferable ingredients include sucrose, dextrin, albumen, chitosan, pectin, cellulose gum, xanthan gum or guar gum.

Frothing Agents

Albumen is an effective frothing agent if its tendency to form turbid solutions in hot cappuccino preparations is controlled. The following powdered components were mixed together:

| Component | Mxture A | Mixture B |
|---|---|---|
| NaHCO₃ | 40 mg | 30 mg |
| Tartaric Acid | 23 mg | 20 mg |
| Ascorbic Acid | 5 mg | none |
| PBS Tween | 8 mg | 6 mg |
| Egg Albumen | 50 mg | 25 mg |
| Instant Latte Mix* | 1 g | 1 g |
| White Mocha Mix** | 300 mg | none |
| Hot Chocolate Mix*** | none | 550 mg |

Mixture A and mixture B were placed in 20 mL test tubes. Hot water was added and the ensuing foam generation was observed. When the temperature of the water used was below about 85° C., a thick, stable and attractive foam was generated ranging from 5% to 40% of the volume of liquid added, depending on the temperature and mixing of beverage. However, when the water was heated to about 90° C. or higher, the foam was generated as usual but a turbid liquid solution formed during only a few minutes, which resembled the look and feel of egg-drop soup.

Instant Latte Mix consisted of: 13.4 g of Maxwell House instant coffee, 35 g of powdered sugar, 19 g of Coffee Mate non-dairy creamer and 2 g of barley malt extract.

The following example illustrates the tendency of dairy proteins to flocculate in foaming hot cappuccino preparations involving an acid-base reaction.

The following powdered components were mixed together:

| Component | Mixture A | Mixture B |
|---|---|---|
| NaHCO₃ | 35.5 mg | none |
| Tartaric Acid | 35.5 mg | none |
| Ca(H₂PO₄)₂ | 16.0 mg | none |
| Instant Foaming Cappuccino Mix* | 1 g | 1 g |

Mixture A contained an acid-base pair and mixture B was a reference standard. 20 mL of 85° C. water was added to each powdered mixture and the ensuing reaction observed. Mixture A generated a larger volume of unstable, poorer quality foam with solid chunks. Mixture A did not resemble a cappuccino. The liquid portion of Mixture A was much clearer than Mixture B. It appeared as though the milk portion of Mixture A had curdled to form solid chunks in the foam Mixture B had a small layer of foam, was much milkier than mixture A and appeared to be a cafélatte.
Coffee mix used was General Foods ”Créme Caramel” instant cappuccino beverage. Cap Expt #0055

The following example illustrates the tendency of acid/base biopolymer couples to flocculate in instant cappuccino preparations.

200 mg of finely-powdered, low molecular weight chitosan in the form of its bitartrate salt is thoroughly mixed with 800 mg of whey protein isolate, 500 mg of potassium bicarbonate and 300 mg of tartaric acid. The powders are mixed thoroughly before the mixtures are each placed in tall glasses of about 7 cm diameter. 165 mL of water at about 85° C. is added to the mixture and it is briefly stirred. A volume of thick foam is generated, however the liquid portion is unappetizingly turbid and viscous.

The following example illustrates the failure of foam stabilizing ingredients to become sufficiently wetted. A mixture of 25 g of KHCO₃, 12 g of whey protein isolate and 8 g of egg albumen were thoroughly mixed as powders. 20 g of H₂O were added to the powdered mixture which was vigorously mixed to a consistent paste. The paste was spread thin on a clean surface and dried overnight at a temperature of about 30° C. with a light air stream blowing over it. The resulting mass was broken up, ground with a mortar and pestle and a fraction of it was passed through a 103 micron mesh. The fractions will be referred to as “Coarse Bicarbonate Compound” and “Fine Bicarbonate Compound” respectively.

The following powders were thoroughly mixed:

| Component | Mixture A | Mixture B |
|---|---|---|
| NaHCO₃ | 35.5 mg | none |
| Tartaric Acid | 35.5 mg | none |
| Ca(H₂PO₄)₂ | 16.0 mg | none |
| Instant Foaming Cappuccino Mix* | 1 g | 1 g |

The mixtures were each placed in tall glasses of about 7 cm diameter, 165 mL of water at about 85° C. was added to each mixture and briefly stirred. The foam quality was observed. Mixture A produced foam which closely resembled that of a true cappuccino, though it collapsed somewhat faster. Mixture B produced foam which contained some small brown spots caused by small lumps of undissolved powder being trapped in the foam. Mixture C produced foam which contained a large amount of brown residue and some lumpy regions of partially dry powder.

Though it may be desirable to have larger amounts of stabilizer in the foam, Mixtures 2 and 3 illustrate the failure of large amounts of stabilizer to become sufficiently wetted.
*Coffee mix used was General Foods “Créme Caramel” instant cappuccino beverage. Experiments: A=#0089 B=#0092 C=# 0090

The following example illustrates the failure of an acid/base pair to react completely in an instant cappuccino preparation. 38.5 mg of shellac coated NaHCO₃, 37.5 mg of tartaric acid and 1 g of instant cappuccino mix were thoroughly mixed before 20 mL of water at 85° C. were added. The ensuing foam generation was observed and the pH of the mixture recorded. The pH of the foam was 4.6 and the pH of the liquid was 3.4. The difference in pH's implies that there is more unreacted acid in the liquid component of the beverage than in the foam.

The following examples illustrate the effectiveness of another embodiment at preventing beverage turbidity due to albumen thermally coagulating. 25 g KHCO₃ and 5 g Albumen were thoroughly mixed as powders. About 4 mL of water was added to the mixture and it was mixed thoroughly to yield a paste. The paste was spread thin on a clean surface and gently heated at 30° C. for 1 hr. before being transferred to a vacuum desiccator and dried over P₂O₅ overnight at a pressure of 25″ Hg less than atmospheric. The mixture was removed from the desiccator and ground using a mortar and pestle.

A mixture was made of 650 mg of the above mentioned powder, 362 mg of adipic acid, 505 mg of whey protein isolate and 6.8 g of a commercial foaming cappuccino mix. The powders were mixed thoroughly and placed in a tall, 7 cm diameter glass before 250 mL of water at 87° C. were added with brief mixing. The foam generated resembled the foam of a true cappuccino and there was no flocculation or turbidity of the liquid.

A mixture was made of 621 mg of the above mentioned powder, 364 mg of adipic acid, 758 mg of nonfat milk solids and 6.8 g of a commercial foaming cappuccino mix. The powders were mixed thoroughly and placed in a tall, 7 cm diameter glass before 250 mL of water at 95° C. were added with brief mixing. The foam generated was somewhat less appealing than the foam of a true cappuccino with small solid particles, but there was no flocculation or turbidity of the liquid.

In another example, 15 g of finely ground KHCO₃, 10 g of powdered sugar and 8.5 g of egg albumen were thoroughly mixed as powders before 10 g of a concentrated solution of KHCO₃ in water are added. The mixture was vigorously stirred until a uniform paste was achieved, then spread thin on a clean surface and allowed to dry at 30° C. under a gentle stream of air before being transferred to a vacuum oven and dried under high vacuum without heating for 5 hr. The resulting dried mass was ground with a mortar and pestle and passed through a 103 micron mesh. The powder is referred to as “bicarbonate-albumen compound” below. The following powders were thoroughly mixed:

| Component | Mixture A | Mixture B |
|---|---|---|
| Bicarbonate-albumen compound | 1.06 g | none |
| Citric Acid | 182 mg | 181 mg |
| Nonfat milk solids | 540 mg | 540 mg |
| Egg Albumen | none | 239 mg |
| Powdered Sucrose | none | 303 mg |
| Potassium Bicarbonate | none | 522 mg |

Mixture A and Mixture B contained the same masses and proportions of ingredients, however in Mixture A, the albumen and sucrose were present as coatings around the potassium bicarbonate. Each mixture was placed in the bottom of a tall glass with a diameter of 7 cm, 165 mL of water at 95° C. were added and each mixture stirred for 15 seconds. Both mixtures appeared milky and generated a fair amount of froth. In both cases, the froth collapsed to less than ⅓ of its initial volume within 2 minutes. The froth in Mixture A remained a cohesive, spongy mass and the froth in Mixture B was notably more prone to break up and yield unappetizing pieces of coagulated material in the liquid portion of the beverage.

The following example illustrates the effectiveness of another embodiment at preventing the coagulation of whey protein during the acid-base reaction. 15 g of whey protein isolate and 20 g of KHCO₃ were thoroughly mixed as powders. 5 mL of water were added to the mixture and the mixture was vigorously stirred until a uniform paste was achieved, then spread thin on a clean surface and allowed to dry under a vacuum of 25″ Hg for 4 hr, then in a vacuum desiccator over P₂O₅ overnight. The resulting solid, flexible mass was allowed to sit uncovered for 4 days until it became dry enough to grind. The resulting dried mass was then ground with a mortar and pestle for 5 minutes, and is referred to as “WPI-bicarbonate compound” below.

The following powders were thoroughly mixed:

| Component | Mixture A | Mixture B |
|---|---|---|
| WPI-bicarbonate compound | 1.00 g | none |
| Ground Citric Acid | 375 mg | 375 mg |
| Whey Protein Isolate | none | 430 mg |
| KHCO₃ | none | 578 mg |

Mixture A and Mixture B contained the same masses and proportions of ingredients, however in Mixture A, the whey protein isolate was present as coatings around the potassium bicarbonate. Each mixture was placed in the bottom of a tall glass with a diameter of 7 cm, 165 mL of water at 85° C. were added and each mixture stirred for 15 seconds. Mixture A was milky while Mixture B was clear. Small, solid white pieces of protein were very conspicuous in Mixture B.

The following example illustrates the effectiveness of another embodiment at preventing the flocculation of acid/base biopolymer pairs in cappuccino preparations. A solution containing 15% KHCO₃, 15% sucrose and 15% whey protein isolate is dried using a pulsed combustion spray drier to yield a powder with an average particle sized of about 150 microns and roughly spherical shape.

The particles are passed through a fluid bed drier while being misted with a solution consisting of 1% by weight low molecular weight chitosan and sufficient adipic acid to completely dissolve the chitosan and yield a pH of about 5.0 to 5.5. The process is adjusted so that the majority of the particles are moistened by the chitosan solution and are dry as they exit the fluid bed, having gained an average of 3.3% of their mass in chitosan. The powder obtained in this manner is referred to as “bicarbonate compound” below. The following powders are thoroughly mixed:

| Component | Mixture A | Mixture B |
|---|---|---|
| Bicarbonate compound | 1.55 g | none |
| Ground Citric Acid | 375 mg | 375 mg |
| Whey Protein Isolate | none | 500 mg |
| KHCO₃ | none | 500 mg |
| Powdered Sucrose | none | 500 mg |
| Powdered Chitosan Adipate | none | 50 mg |

Mixture A and Mixture B contain the same masses and proportions of ingredients, however in Mixture A, the biopolymers are present as coatings around the potassium bicarbonate. Each mixture is placed in the bottom of a tall glass with a diameter of 7 cm, 165 mL of water at 85° C. are added and each mixture is stirred for 15 seconds. Both mixtures generate foam, however Mixture A contains noticeably less solid material in the liquid portion and it is clear that Mixture B does not dissolve completely.

The following example is another embodiment for preparing a composition that illustrates the importance of wetting the composition prior to commencing substantial frothing action. Good wetting increases the liquid component in the froth, making it creamier, and reduces the amount of non-wetted particles found in the froth. A mixture of 25 g of KHCO₃, 12 g of whey protein isolate and 8 g of egg albumen were thoroughly mixed as powders. 20 g of H₂O was added to the powdered mixture which was vigorously mixed to a consistent paste. The paste was spread thin on a clean surface and dried overnight at a temperature of about 30° C. with a light air stream blowing over it. The resulting mass was broken up, ground with a mortar and pestle and a portion of it was passed through a 103 micron mesh. The portion that passed through the screen is referred to as the “Fine Bicarbonate Compound.” The portion that failed to pass through the mesh is referred to as the “Coarse Bicarbonate Compound.”

In one example, 1 g of the fine bicarbonate compound is gently heated and stirred while a concentrated solution of sucrose in methanol is slowly dropped onto it. The addition of the methanol solution proceeds at a slow rate such that the mixture does not become pasty. The addition of the methanol solution continues until about 20 milliliters (mL) have been added and the dry powder has a mass of 1.2 g. This powder is thoroughly mixed with 6.8 g of instant cappuccino mix. The powder is gently heated and stirred until all traces of methanol have evaporated. Alternatively, another solvent, such as ethanol, may be substituted for methanol. For example, if ethanol is used, then it is preferable to use a volume of ethanol that is about 1.5 times the amount of methanol used. If done properly, it is believed that the process results in the bicarbonate compound being coated with 200 mg of the sucrose, for example.

The mixture is placed in tall glasses of about 7 cm diameter, 165 mL of water at about 85° C. is added to the mixture and it is briefly stirred. It is believed, without limiting the invention in any way, that the use of the sucrose coating delays frothing and produces a higher quality froth than the particles of bicarbonate compounded with foaming agent, because more liquid is included in the froth and fewer unwetted particles are included in the froth.

The following example illustrates the effectiveness of another embodiment with respect to increasing the efficiency of the foam-generating acid-base reaction. 10 g of NaHCO₃ (particle size less than 20 microns) are gently heated and stirred while a concentrated solution of adipic acid in acetone is dropped onto it. The addition of adipic acid is continued until the mass of the NaHCO₃ has increased to 17 g. The mass may be used as a block or powdered and encapsulated as in some of the previous methods. For example, this material may be substituted for both the unencapsulated NaHCO₃ (particle size less than 20 microns) and the acid in a cappuccino formulation. In another example, the mass coated with a frothing agent, includes a frothing agent or is powdered and coated with a frothing agent. The resulting mass or particles may also be coated with another compound to delay frothing until sufficient wetting of the particles takes place. It is believed, without limiting the claims in any way, that the compounding of the acid and the bicarbonate is responsible for decreasing the difference in pH between the foam and liquid portions compared to other examples that use separate bicarbonate and acid.

In another example of a successful instant cappuccino mix, a mixture was prepared by combining 26 g of whey protein isolate, 17 grams of KHCO₃ and 23 grams of a concentrated solution of KHCO₃ in water. The mixture was mixed to a homogenous paste, spread thin on a clean surface and allowed to dry at room temperature overnight under a gentle stream of air. The mixture was ground using a mortar and pestle and the coarse particles were collected by screening with a 106 micron mesh. The resulting particles appeared to be about the same size and shape as common table salt. The powder obtained in this manner is referred to as “bicarbonate-whey compound” below.

Another mixture was prepared by combining 15 g of egg albumin powder with 20 g of of KHCO₃. The mixture was mixed to a homogenous paste, spread thin on a clean surface and allowed to dry at room temperature overnight under a gentle stream of air. The mixture was ground using a mortar and pestle and the fraction which passed a 56 micron mesh was collected. The powder obtained in this manner is referred to as “bicarbonate-albumin compound” below. The following powders are thoroughly mixed:

| Component | Mixture A | Mixture B | Mixture C |
|---|---|---|---|
| Bicarbonate Whey | 600 mg | None | None |
| Compound | | | |
| Bicarbonate Albumin | 500 mg | None | None |
| Compound | | | |
| Whey Protein Isolate | 700 mg | 700 mg | None |
| Cellulose Gum | 200 mg | 200 mg | None |
| Citric Acid | 350 mg | 350 mg | None |
| Potassium Bicarbonate | None | 412 mg | None |
| Instant Cappuccino Mix | One package | One package | One package |
| | (25 g) | (25 g) | (25 g) |

Mixture C was prepared as directed on the package of instant cappuccino mix (prior art). The froth on Mixture C was of small volume, resembling a latte, but failed to resemble a true cappuccino froth. The bubbles appeared to be about the same size as in Mixture B.

Mixture B was prepared as directed on the package of instant cappuccino mix, except that additional ingredients were added. Mixture B contains the same amount of acid and bicarbonate as mixture A, but failed to create an acceptable froth. The bubbles were large than the bubbles in Mixture A and dissipated more rapidly than the bubbles of Mixture A.

Mixture A was prepared as directed on the package of instant cappuccino, except that additional ingredients were added. The bicarbonate of Mixture A was compounded with frothing additives and achieved a much more appealing froth than either Mixtures B or C. Indeed, the froth most closely resembled a true milk froth made by hand steaming of the milk. The bubbles were smaller and lasted longer. The volume of the froth was better and was retained longer than the other Mixtures. There was substantially no flocculation of the albumen and substantially no increase in turbidity or viscosity of Mixture A.

In Table A, the height of the foam is recorded over time. Each of the mixtures were placed in tall glasses of about 7 cm diameter, 165 mL of water at about 85° C. was added to each mixture, and the mixtures were stirred for about 15 seconds. The height of the foam was recorded immediately after mixing, 3 min after the water was added and 5 min after the water was added.

TABLE A
Results of Comparison Test

| | Foam Height | Foam Height | Foam Height |
|---|---|---|---|
| | (15 s) | Height (3 min.) | (5 min.) |
| Mixture A | 47 | 21 | 16 |
| Mixture B | 47 | 17 | 9 |
| Mixture C | 10 | 9 | 8 |

The process of preparing a cappuccino using Mixture A was repeated several times to investigate the effect of preparation variables on the volume of the froth. The results are tabulated in Table B.

TABLE B
Results of Varying Temperature and Mixing for Mixture A

| | Foam Height | Foam Height | Foam Height |
|---|---|---|---|
| Mixture A | (15 s) | (3 min.) | (5 min.) |
| 90° C. | 50 | 24 | 18 |
| 87° C. | 47 | 21 | 16 |
| 77° C. normal mixing | 35 | 18 | 14 |
| 77° C. vigorous mixing | 30 | 17 | 14 |
| 77° C. slow mixing | 32 | 16 | 13 |

Table B shows that mixing rate (i.e. slow, normal and vigorous) has little effect on the volume of froth produced. Water temperature influences the volume of froth produced, with higher temperatures increasing the volume compared to lower temperatures. There was no substantial flocculation of the albumin, even at the highest temperature tested. Thus, the compounding of the bicarbonate with the albumin is very advantageous, allowing very hot water to be used to create the maximum height of a satisfying froth on the cappuccino.

In another example, a first mixture was prepared by combining 10 g of whey protein isolate, 10 grams of KHCO₃, 5 g of a 30% colloidal solution of silica and 20 grams of a concentrated solution of KHCO₃ in water. The mixture was mixed to a homogenous paste, spread thin on a clean surface and allowed to dry at room temperature overnight under a gentle stream of air. The mixture was ground using a mortar and pestle and the coarse particles were collected by screening with a 106 micron mesh. The resulting particles appeared to be about the same size and shape as common table salt. The powder obtained in this manner is referred to as “bicarbonate-whey-silica compound” below.

A second mixture was prepared by combining 10 g of whey protein isolate, 15 grams of KHCO₃, 1 g of Xanthan gum and 15 grams of a concentrated solution of KHCO₃ in water. The mixture was mixed to a homogenous paste, spread thin on a clean surface and allowed to dry at room temperature overnight under a gentle stream of air. The mixture was ground using a mortar and pestle and the fraction which passed a 56 micron mesh was collected. The powder obtained in this manner is referred to as “bicarbonate-whey-xanth compound” below.

A third mixture was prepared by combining 10 g of egg albumin powder, 10 g of KHCO₃ powder, 1 g of powdered guar gum and 16 g of a concentrated solution of KHCO₃ in water. The mixture was mixed to a homogenous paste, spread thin on a clean surface and allowed to dry at room temperature overnight under a gentle stream of air. The mixture was ground using a mortar and pestle and the fraction which passed a 56 micron mesh was collected. The powder obtained in this manner is referred to as “bicarbonate-albumin compound” below.

Then, 2 g of the bicarbonate-whey-silica compound, 500 mg of the bicarbonate-whey-xanth compound, 2.5 g of the bicarbonate-albumin compound, 1 g of powdered cellulose gum, 900 mg of tartaric acid and 100 mg of ascorbic acid were thoroughly mixed as powders. The powders were heated to about 30° C. before 3 g of an 8% solution of shellac dissolved in a solvent comprised of 2 parts acetone and 1 part isopropanol were added. The mass was thoroughly mixed to yield a thick paste then spread thin and allowed to dry at 30° C. under a gentle stream of air. The cake was completely dry after about 2 hours and was broken up with a spatula to yield coarse granules. The granules obtained in this manner will be referred to as “shellac cake.”

Then, 1.2 g of the shellac cake were mixed with 1 g of whey protein and one package of instant cappuccino. The mixture was placed in tall glasses of about 7 cm diameter, 165 mL of water at about 85° C. was added and the mixture was stirred for about 15 seconds. The height of the foam was recorded immediately after mixing, 3 min after the water was added and 5 min after the water was added and are tabulated in Table C.

TABLE C
Results for Shellac Cake

| Foam Height | Foam Height | Foam Height |
|---|---|---|
| (15 s) | (3 min.) | (5 min.) |
| 19 mm | 13 mm | 9 mm |

The reaction between the acid and the bicarbonate was noticeably delayed relative to Mixtures A and B in Table A. There was no coagulation and the beverage looked, smelled and tasted appealing. While the volume of froth was less than either Mixtures A or B, the froth maintained a substantially greater head than Mixture C for a period of at least 3 minutes.

1. A composition for use in producing a froth in an instant hot beverage, comprising:
a first ingredient selected from the group of first ingredients consisting of an acid and a bicarbonate; and
a second ingredient selected from the group of second ingredients consisting of a frothing agent and a coating agent, wherein the first ingredient and the second ingredient are compounded.

2. The composition of claim 1, wherein the first ingredient is comprised of a bicarbonate and the second ingredient is comprised of a frothing agent.

3. The composition of claim 2, further comprising an acid, wherein the acid is compounded with the bicarbonate forming compounded particles of bicarbonate and acid, and the compounded particles are subsequently compounded with the frothing agent, such that the frothing agent forms a film on the compounded particles.

4. The composition of claim 3, wherein the acid is an acid selected from the group of acids consisting of an acidic biopolymer, a gluconolactone, a gluconic acid, a citric acid, a tartaric acid, a malic acid, a malonic acid, a succinic acid, a glutaric acid, an adipic acid, an ascorbic acid, a monobasic salts of phosphoric acid and combinations thereof.

5. The composition of claim 4, wherein the acid is an adipic acid.

6. The composition of claim 5, wherein the compounded particles of bicarbonate and acid are comprised of a bicarbonate core and a film of acid on the bicarbonate core.

7. The composition of claim 1, wherein the first ingredient is comprised of a bicarbonate and the second ingredient comprises an acidic biopolymer compounded with a frothing agent, and the second ingredient is compounded with the first ingredient such that the second ingredient is deposited as a film on the first ingredient.

8. The composition of claim 7, wherein the frothing agent includes a basic biopolymer.

9. The composition of claim 8, wherein the frothing agent further includes at least one substance selected from the group of substances consisting of a sucrose, a fructose, a guar gum, a xanthan gum, a pectin, a casein, salts of casein, nonfat milk solids, whey proteins, powdered nondairy creamer, an instant coffee, a sorbitan-ester surfactant impregnated into solid phosphate salts, a silica, a malt extract and combinations thereof.

10. The composition of claim 9, wherein the at least one substance is a sucrose.

11. The composition of claim 2, wherein the compounded bicarbonate and frothing agent is pulverized into a powder.

12. The composition of claim 11, wherein the powder comprises a core comprising the bicarbonate and a coating comprising the frothing agent.

13. The composition of claim 12, wherein the core, the coating or both the core and the coating further comprise an acid.

14. The composition of claim 2, wherein the compounded bicarbonate and frothing agent comprises a plurality of particles comprising bicarbonate within a matrix comprising the frothing agent.

15. The composition of claim 14, wherein the matrix further comprises an acid.

16. The composition of claim 14, wherein the plurality of particles further comprises an acid.

17. The composition of claim 15, wherein the matrix further comprises at least one substance selected from the group of substances consisting of a sucrose, a fructose, a guar gum, a xanthan gum, a pectin, a casein, salts of casein, nonfat milk solids, whey proteins, powdered nondairy creamer, an instant coffee, a sorbitan-ester surfactant impregnated into solid phosphate salts, a silica, a malt extract and combinations thereof.

18. The composition of claim 17, wherein the at least one substance is a sucrose.

19. The composition of claim 1, further comprising a polymeric substance, wherein the polymeric substance is compounded with the bicarbonate forming compounded particles of bicarbonate having a core comprised of the bicarbonate and a film of the polymeric substance on the core, and the polymeric substance is selected such that dissolution of the compounded particles in hot water is delayed, and the compounded particles are subsequently compounded with the frothing agent, such that the frothing agent forms another film on the compounded particles.

20. The composition of claim 19, further comprising an acid, wherein the acid is compounded with the bicarbonate prior to compounding with the polymeric substance such that the acid forms a first film on the core, the film of the polymeric substance is a second film, and the another film of the frothing agent is a third film.

21. A process of preparing a composition for use in an instant hot beverage, comprising:
compounding a bicarbonate powder and an acid;
forming particles of the compound formed during the step of compounding; and
coating the compound with a substance selected from the group of substances consisting of a frothing agent, a coating substance, and combinations thereof.

22. An instant cappuccino mix, comprising:
an instant coffee;
an instant milk or milk substitute;
an edible acid;
a first ingredient selected from the group of first ingredients consisting of an acid and a bicarbonate; and
a second ingredient selected from the group of second ingredients consisting of a frothing agent and a coating agent, wherein the first ingredient and the second ingredient are compounded.

23. The instant cappuccino mix of claim 22, wherein the first ingredient is of a bicarbonate and the second ingredient is of an albumen.

24. The instant cappuccino mix of claim 23, further comprising a bicarbonate compounded with a whey protein.
